(19) United States
(12) Patent Application Publication
(10) Pub. No.: US 2009/0229730 A1
(43) Pub. Date: Sep. 17, 2009

(54) PROCESSING DEVICE

(75) Inventors: Hugo Voss, Langenberg (DE); Werner BRINKHAUS, Rheda-Wiedenbrueck (DE)

Correspondence Address: HARNESS, DICKEY & PIERCE, P.L.C., P.O. BOX 828, BLOOMFIELD HILLS, MI, 48303, US

(73) Assignee: Weeke Bohrsysteme GmbH, Herzebrock-Clarholz (DE)

(21) Appl. No.: 12/401,817

(22) Filed: Mar. 11, 2009

(30) Foreign Application Priority Data
Mar. 12, 2008 (EP) 08004574.3

(51) Int. Cl. B32B 37/12; B05C 13/00

(52) U.S. Cl. 156/60; 118/500; 156/538

(57) ABSTRACT

The invention relates to a processing device for processing workpieces that are preferably made at least partially of wood, wooden materials, plastics or the like, comprising a machine bed and at least one processing unit joined to the machine bed, wherein the machine bed comprises a base body that is made at least in sections of concrete, in particular steel reinforced concrete. The processing device of the invention is characterised in that the base body comprises a preferably planar base portion and at least one shank portion.

### FIELD

The invention concerns a processing device for processing work pieces, which are preferably made at least in part of wood, wooden material, plastics or the like, according to the introductory portion of claim 1.

### BACKGROUND

Processing devices of the above-mentioned type are widely used in the furniture and building component industry as well as other industrial branches when processing and manufacturing work pieces. For example, these machines can be used for machining, coating, edge gluing or various other finishing processes. The processing units of these machines are usually built upon a machine bed, which traditionally is made of steel or sheet steel. The increasing processing speeds and the dynamic load of the processing machines associated therewith bring about that the oscillation characteristics of the machine bed supporting the components of the machine continuously gain in importance. Against this background it has been proposed to manufacture the machine bed from mineral casting, that is a mixture of a synthetic binder and additives (see for example DE 20 2006 323 U1).

As an alternative thereto, machine beds consisting partially of reinforced concrete have lately been employed. The applicant, for instance, commercialises a CNC portal processing centre type Vantage 33M in which a rectangular plate of steel reinforced concrete is arranged on a base frame of sheet steel in order to form the machine bed. Within the framework of the present application, concrete is to be understood as cementitious concrete.

The rectangular reinforced concrete plate of the known CNC portal processing centre proved its worth in practical use due to its high rigidity and its high self-weight. It turned out, however, that such an reinforced concrete plate can be adapted to different machine types only with difficulties, or that each machine type requires its own formwork to be produced for casting the reinforced concrete body. Apart from a low of flexibility, this results in a high capital expenditure and space requirements as well as an involved production process.

### SUMMARY

It is therefore an object of the present invention to provide a processing device of the generic type, the machine bed of which can be made of components that have a simple structure and can be employed in many ways, i.e. for different machine types.

According to the invention, this object is achieved by a processing device according to claim 1. Particularly preferred embodiments of the invention are defined in the dependent claims.

The invention is based upon the notion that machine beds for a wide variety of machine types can be produced with a low number of concrete components. To that end the invention envisions that the base bloody comprises a preferably flat base portion and at least one shank portion provided at an angle thereto.

In this way it becomes possible to use the base bloody in a first alignment (for example shank up) as the machine bed for a so-called console table, and to use it in a second alignment (for example shrank down) as machine bed for a so-called desktop machine.

Thereby, production can be a highly standardised so that it is possible to work with less formwork elements or in the extreme case with only one formwork element for the concrete. Thereby it is possible not only to reduce investment costs and space requirements, but is also possible to avoid sources of error and spread.

According to afford an embodiment of the invention it is envisioned that the base body comprises at least two shank portions so that the base body has a preferably a substantially U-shaped or triangular cross-section. In this way, it is possible to achieve the above advantages with a particularly low number of additional components. Thus, it is possible to build a desktop machine or a console machine with a base body having a U-shaped cross-section without any additional sub-frame or superstructure. Similar advantages can be achieved with a triangular cross-section, wherein this cross sectional shape in addition has a particularly high stability. In this way, the provision of at least two shank portions allows for a high variability at low manufacturing expenditure and high stability.

According to a further embodiment of the invention it is moreover envisioned that the base body comprises at least one steel profile. Such a steel profile not only contributes to an increased stability and strength of the base body but many moreover serve also as a precisely defined support surface or precise guide for movable machine elements. Herein, it is particularly preferred that at least one steel profile is set in concrete in order to achieve a secure joint between the steel profile and the surrounding concrete. However, it can also be envisioned to glue or otherwise subsequently attach the steel profile to the surrounding concrete, for example. Thereby, the variability of the base body can be increased and a more precise positioning of the steel profile may possibly be reached, which is particularly advantageous when using the steel profile as guide or support surface.

Especially for these applications it is advantageous if, according to a further embodiment of the invention, the at least one steel profile is arranged on a surface of the base body, in particular in the region of the free end or a corner of the base body. Further, such a configuration is particularly easy to produce and protects the surrounding concrete during handling of the base body.

Although the base portion and the at least one shank portions of the base body provided at an angle thereto may integrally be made of concrete or steel reinforced concrete, a further embodiment of the invention envisions that the base body is formed in several parts having several portions has. Thereby, the base body may be constructed as in a modular system so that (reinforced) concrete bodies may be prefabricated with a simple geometry in simple formworks and may be produced on stock, if need be, in order to assemble the portions subsequently into a base body as a function of the desired machine configuration. Thereby, it is possible to achieve maximum flexibility with simple production, while at the same time a virtually immediate availability of the desired base body can be ensured.

Although in this concept also the base portion of the base body may be formed from several parts, it is envisioned according to a further embodiment of the invention that at least one shank of the base body is subsequently joined with the preferably planar base portion of the base body. This concept is based upon the realisation that the variability requirements of the subject processing devices are primarily concentrated in a vertical direction so that a combinability of a certain base body with different shanks results in an optimum variability.

With the above-described “modular concept” individual or multiple parts of the base body may be made of other materials than concrete or reinforced concrete so that according to a further embodiment of the invention at least on shank portion may also comprise a steel profile. Thereby, tailored solutions can be created for a great variety of applications, which are able to securely and economically fulfil the high demands on stability, oscillation behaviour and dimensional precision.

Within the framework of the present invention, the joining together of the individual components of the multi-part base body may be effected in a wide variety of ways. According to a further embodiment of the invention, it is envisioned, however, that the portions of the base body are glue together at least in sections. Thus, dimensional tolerances occurring frequently in concrete or reinforced concrete can be compensated, and a simple production results. Alternatively or additionally it is also possible to tooth the portions of the base body together at least in sections so that, especially in combination with gluing, the transmission of high loads on a long-term basis is made possible. Further it has to be observed that in addition to gluing and/or toothing together also screwing together or another joint of the portions is envisioned.

According to a further embodiment of the invention, it is moreover envisioned that the base body comprises at least one recess or profiling. In this way, without a substantial decrease in rigidity, a weight reduction and material savings can be achieved so that the oscillation behaviour can optimally be adjusted to the respective application and the cost-effectiveness can be improved.

An advantageous method for producing a processing device according to the invention is the subject-matter of claim 10. It is particularly characterized in that at first at least two base body portions are produced, at least one of which comprises concrete, preferably reinforced concrete. According to the invention, the base body portions are then joined together for forming the base body, in particular they are glued together at least in sections. In this way the advantages of the principle of modularity explained above may be realised in an optimum way.

### DRAWINGS

FIG. 1 schematically shows a perspective view of a processing device according to a first embodiment of the present invention;

FIG. 2 schematically shows a perspective view of a processing device according to a second embodiment of the present invention;

FIG. 3 schematically shows a perspective view of a processing device according to a third embodiment of the present invention;

FIG. 4 schematically shows a perspective view of a processing device according to a fourth embodiment of the present invention;

FIG. 5 schematically shows a perspective view of a processing device according to a fifth embodiment of the present invention.

### DETAILED DESCRIPTION

In the following, preferred embodiments of the present invention will be described in detail by reference to the accompanying drawings.

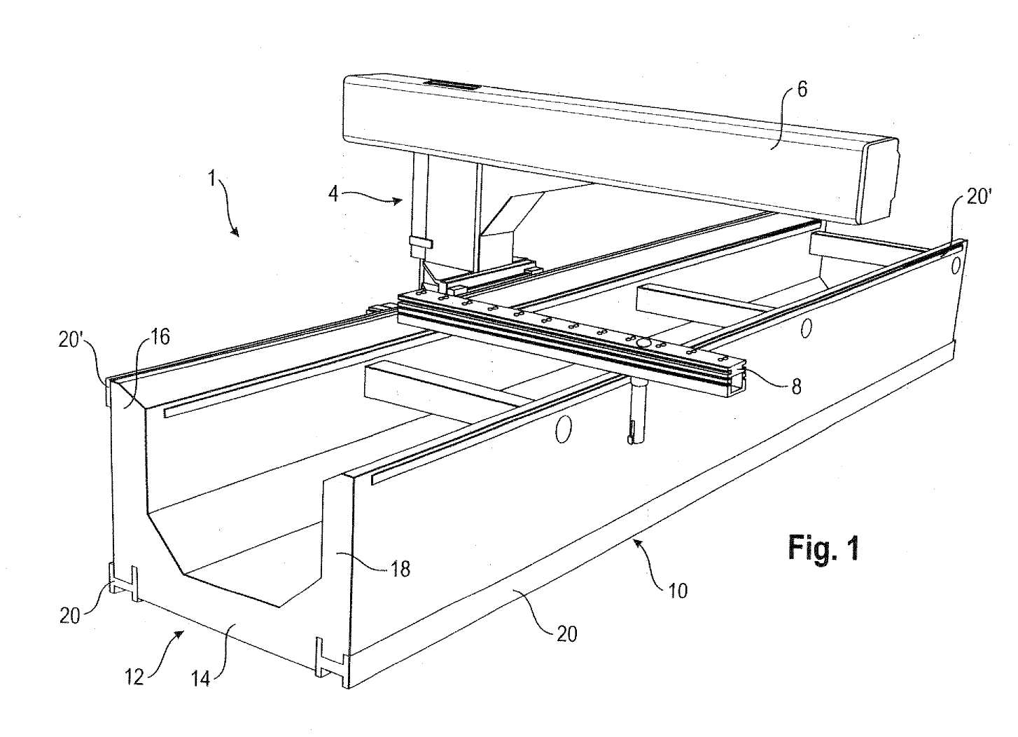

A processing device 1 as preferred embodiment of the present invention is schematically illustrated in the perspective view of FIG. 1. The shown processing device 1 is, in the present embodiment, a CNC machining centre, although the present invention is not restricted thereto and various stationary or throughfeed machines may be configured according to the invention as well. In the present embodiment, the processing device 1 serves for processing workpieces (not shown in FIG. 1) that are, for example, made of wood, wooden materials, plastics or the like, such as those used frequently in the field of the furniture and construction components industries. To this end the processing device 1 comprises a processing unit 4, which in the present embodiment is formed by a travelling column or arm 6 and one or more processing aggregates (not shown) provided thereon.

The travelling column 6 is translatable along a machine bed 10 which will be described in more detail in the following. Several consoles 8 (only one of which is shown in FIG. 1) are arranged on the machine bed in order to support and hold the workpieces to be processed (not shown), for example by means of vacuum and/or other jigs (clamping devices). Here, the consoles 8 may be adjustable along the machine bed 10 in a known manner.

The machine bed 10 comprises a base body 12 that is made, in the present embodiment, mainly of reinforced concrete. Within the framework of the present invention, concrete is to be understood as cementitious concrete which is, for example, produced according to DIN 1045. This may be normal-strength, high-strength or ultrahigh-strength concrete having a burst strength of 200 MPa or more. In these cases the concrete will comprise different, partly synthetic additives, wherein primarily cement continues to be used as binder. Moreover, within the framework of the present invention, reinforced concrete indicates concrete provided with un-tensioned or pre-tensioned reinforcement which may be made of steel but also of other materials such as fibre composites or the like.

In the present embodiment, the geometry of the base body 12 is substantially U-shaped so that the base many 12 has a planar base portion 14 and two shank (side) portions 16, 18 provided under an angle thereto. The angle between the base portion and the shank portions may be varied in many ways so that through a corresponding inclination of the shank 18, for example, also a triangular cross-section or several other cross-sections may be produced.

In the present embodiment, the base body 12 comprises four steel profiles 20, 20′ which are set in the concrete of the base body 12. To that end the steel profiles 20, 20′ may be provided with suitable anchoring means such as head bolts, loops or the like. Here, as can be seen from FIG. 1, the steel profiles 20 are arranged so that they serve as support surface for the base body 12, while the steel profile 20′ is arranged in the region of the free end of the shank 16 so that it can serve as guide for a translational movement of the travelling column 6. Moreover, the steel profiles 20, 20′ impart additional stability and crack safety to the base body 12.

Although also not shown in FIG. 1, the base body 12 may also be formed from several parts, for instance by joining shanks 16 and/or 18 subsequently to the base portion 14, which will be explained in more detail in the following.

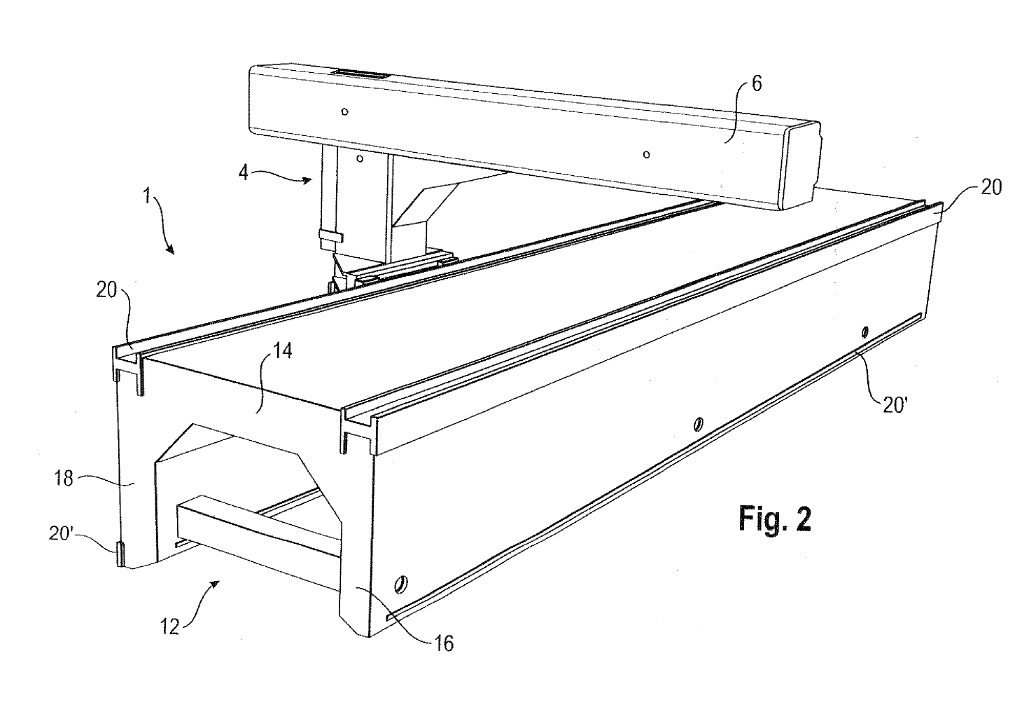

A second preferred embodiment of the inventive processing device is schematically shown in the perspective view of FIG. 2. In principle, in this processing device, the same base body 12 is employed like in the first preferred embodiment, but in the second embodiment it is arranged standing head-down so as to give a desktop machine. The base body 12 according to the invention can thus be employed variously and flexibly so that a great variety of machines may be produced with a single formwork or a single set of formworks.

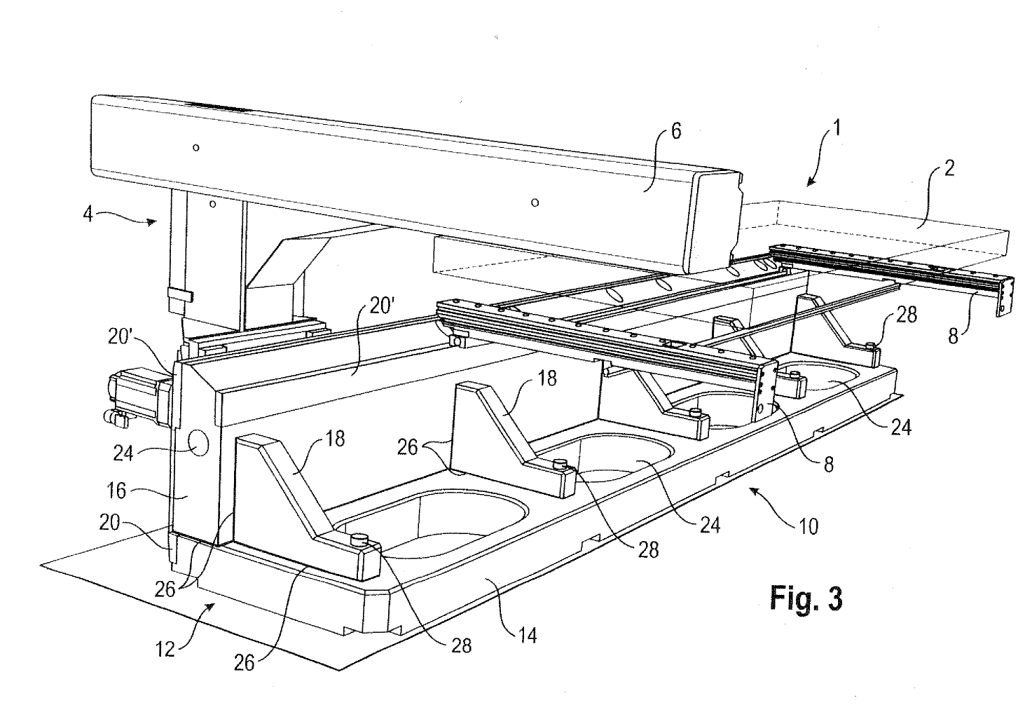

A third preferred embodiment of the present invention is schematically shown in the perspective view of FIG. 3 This machine is, as in the first preferred embodiment of FIG. 1, a CNC processing centre having a travelling column 6 translatable along the base body 12. To support and fix the workpiece 2 shown in FIG. 3 consoles 8 are in turn provided on the base body 12. However, the third embodiment differs from the preceding embodiments in the configuration of the base body 12 which in the present embodiment is formed in several parts comprising a base portion 14, a shank 16 and a plurality of transverse struts (supports) 18. These components are joined together at least in sections by means of a glue layer 26, wherein screws 28 are additionally provided for joining the transverse struts 18 and the base portion 14. Moreover, the joining surfaces between the respective components may additionally comprise toothings or profilings, although this is not shown in FIG. 3.

Moreover, in the embodiment shown in FIG. 3 the base body has a plurality of recesses 24, namely both in the region of the planar base portion 14 and in the region of shank 16. In this way, oscillation behaviour, self-weight and rigidity of the base body can be adjusted to each other and the material savings and transport weight may be optimised.

In order to produce the base body shown in FIG. 3, the individual base body portions 14, 16 and 18 are at first prepared in the respective formworks, with the formworks preferably being reusable formworks having a high-strength formwork facing made, for instance, of steel or the like. Here, like in the embodiment shown in FIG. 1, the steel profiles 20 or 20′ may already be set in concrete in the base portion 14 and the shank 16, although they can also be attached, in particular glued subsequently to the respective components.

Then, the joining surfaces are prepared for the subsequent joining operation and are provided with a glue layer 26 in order to join now the components 14, 16 and 18 to each other. For a precise and secure connection of the individual components various auxiliary constructions may be employed, such as support frames, support blocks or the like. The individual components may thus be held in a desired reference position, in which the distance between the upper steel profile 20′ and the lower steel profile 20 is defined, for example, wherein the glue layer 26 then serves as tolerance compensation. In this way, a base body having highly precise dimensions may be produced, which otherwise can be realised only by means of structural steel work.

Then, the components 14, 16 and 18 may additionally be screwed together or non-positively joined in another way, although this is not absolutely necessary. In the opposite case it is to be observed that instead of gluing the single components 14, 16, 18 together, other joining techniques may be employed as well, such as mere screwing or another positive joining of the components etc.

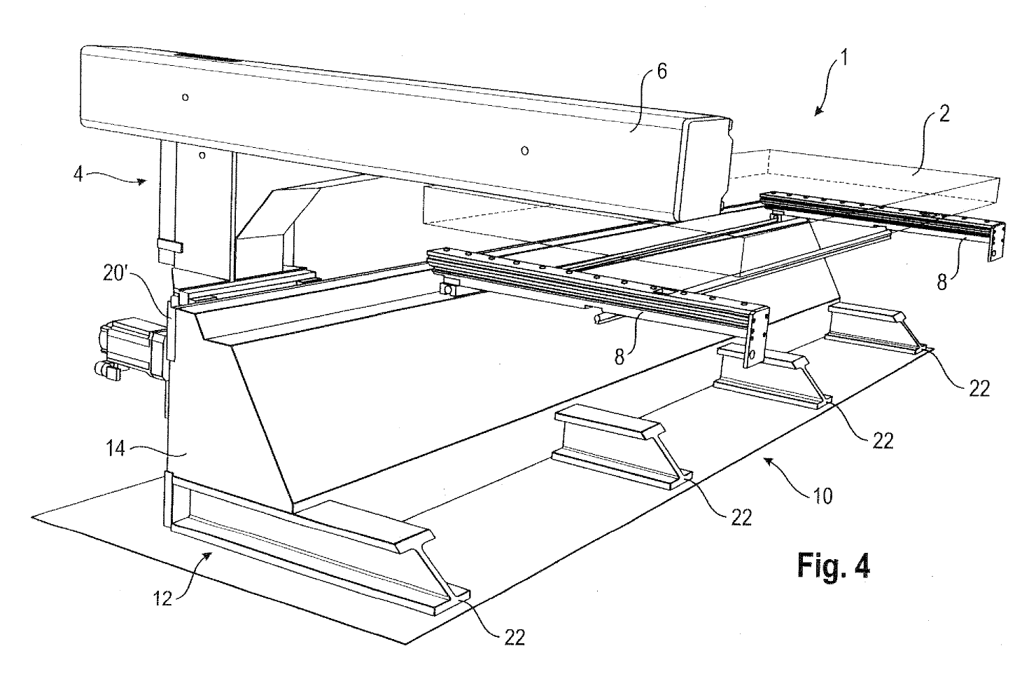

A fourth preferred embodiment of the present invention is schematically shown in the perspective view of FIG. 4. This differs from the embodiments described hitherto primarily in that the base body 12 comprises a base portion 14, arranged standing here, and several shanks 22 joined thereto and being formed by steel profiles. In the present embodiment, the steel profiles are set in concrete in the base portion 14. It is, however, equally possible to subsequently join, for example to glue or screw the shanks 22 to the base portion 14 etc.

Moreover, within the framework of the present embodiment it is equally possible to set up the base body 12 in a different alignment, for instance with the base portion 14 pointing down and the shanks 22 being aligned vertically. In this case, a suitable guide for a travelling column or also for any other type of machine construction may be attached at the free end of the shanks 22. Further, it may be expedient to design the base portion 14 also in this embodiment to be at least partially hollow or with recesses so as to achieve an optimum ratio between weight, rigidity and oscillation behaviour.

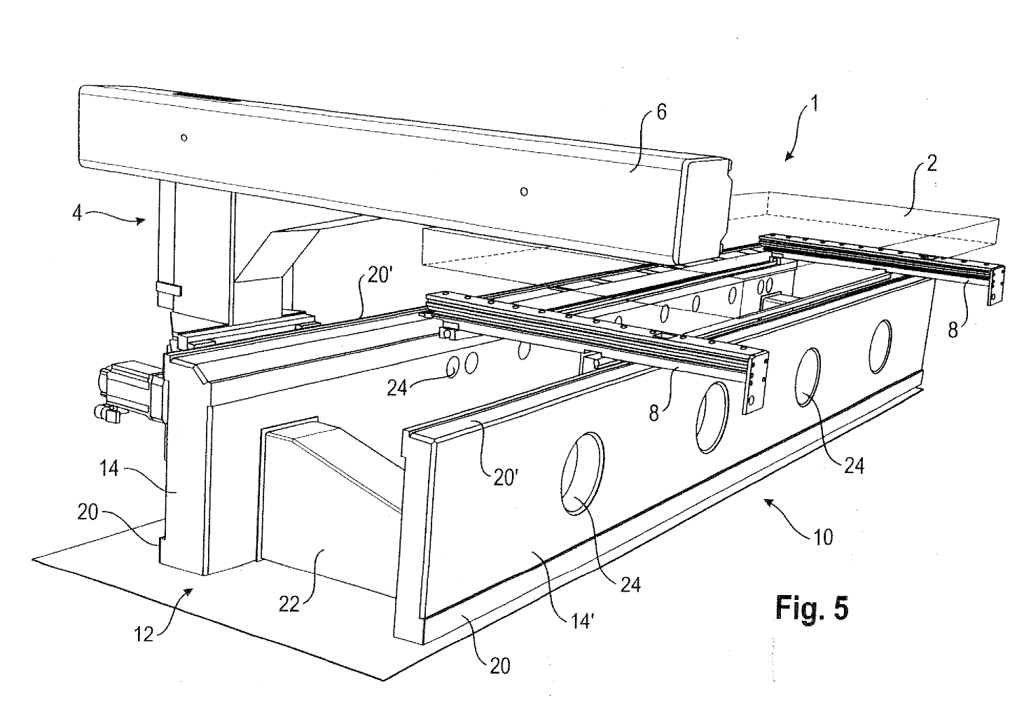

A fifth embodiment of the present invention is schematically shown in the perspective view of FIG. 5. This ties in with the concept of the embodiment shown in FIG. 4, in which the base body 12 comprises a base portion 14 and steel profiles connected (e.g. set in concrete) thereto as shanks. Additionally, in the present embodiment the base body comprises a second base portion 14′ joined to the free end of steel support 22. Although also this connection may be effected by setting (casting) in concrete, it will be expedient in many cases to possibly provide a subsequent joint by gluing, screwing etc, in order to simplify the production and, possibly, the transport.

Also this base body may advantageously be used in different positions, which can be adapted to the respective machine type, for example according to FIG. 5 for a processing machine with console 8, or possibly for a desktop machine (not shown), the desktop (table) of which can then rest upon the base portions 14, 14′ as well as upon the surface of the steel supports 22 flush therewith.

The machine bed consisting at least in sections of concrete may be a machine bed extended subsequently by concrete, (e.g. by means of gluing, screwing.)

1. A processing device for processing workpieces that are preferably made at least partially of wood, wooden materials, plastic or the like, comprising:
a machine bed and at least one processing unit joined thereto, wherein the machine bed comprises a base body that is made of concrete, in particular reinforced concrete, at least in sections, characterised in that
the base body comprises a preferably planar base portion and at least one shank portion provided at an angle thereto.

2. The processing device of claim 1, wherein the base body comprises at least two shank portions so that the base body preferably comprises a substantially U-shaped or triangular cross-section.

3. The processing device of claim 1 or 2, wherein the base body comprises at least one steel profile.

4. The processing device of claim 3, wherein the at least one steel profile is arranged on a surface of the base body.

5. The processing device of claim 1, wherein the base body is formed in several parts having a plurality of portions.

6. The processing device of claim 5, wherein the at least one shank of the base body is joined subsequently to the planar base portion of the base body.

7. The processing device of claim 5 or 6, wherein at least one shank portion comprises reinforced concrete or a steel profile.

8. The processing device of any of claim 5 or 6, wherein the portions of the base body are toothed or glued to each other at least in sections.

9. The processing device of claim 2, wherein the base body has at least one recess or profiling.

10. A method for producing a processing device according to claim 1, comprising the steps of:
producing at least two base body portions, of which at least one contains concrete, and
forming a base body by joining the base body portions to each other at least in sections.

11. The processing device of claim 3 wherein said at least one steel profile is set in concrete.

12. The processing device of claim 4 wherein said at least one steel profile is arranged on a surface of the base body in the region of a free end or cover of the base body.

13. The method of claim 10 wherein the concrete employed is fiber reinforced.

14. The method of claim 10 wherein the base body portions are glued together.
